(19) United States
(12) Patent Application Publication
(10) Pub. No.: US 2005/0165565 A1
(43) Pub. Date: Jul. 28, 2005

(54) Compressor performance approximation using Bin Analysis data

(75) Inventors: John Byrnes, Marietta, NY (US); Paul Tollar, Liverpool, NY (US); Michael Collins, Syracuse, NY (US)

Correspondence Address: CARRIER CORPORATION, ONE CARRIER PLACE, INTELLECTUAL PROPERTY DEPARTMENT, FARMINGTON, CT, 06034, US

(73) Assignee: CARRIER CORPORATION, Syracuse, NY (US)

(21) Appl. No.: 10/936,053

(22) Filed: Sep. 7, 2004

Related U.S. Application Data
(60) Provisional application No. 60/500,546, filed on Sep. 5, 2003.

(51) Int. Cl. G06F 19/00

(52) U.S. Cl. 702/60

(57) ABSTRACT

A method of calculating energy usage for compressor groupings including the steps of providing bin data for a specific geographical location; inputting desired compressor models and quantities of compressors; inputting compressor data including desired loading characteristics of the compressors; and calculating performance data including energy usage of the compressor grouping.

### FILED OF THE INVENTION

This invention is directed to energy usage projections for refrigeration and conditioning compressors.

### BACKGROUND OF THE INVENTION

Bin Analysis involves obtaining temperature ‘Bin’ data for the location that a user wishes to study. Bin data is typically supplied by the US Air Force.

Weather data for a location (including the outdoor temperature) is measured and recorded over a long period of time. The data is then compiled in 5 degree temperature bins. This data is then used to approximate the conditions that any Air Conditioning or Refrigeration equipment are subjected to (on average) at the location. The outside temperature is the primary factor in how efficiently this type of equipment operates (although the humidity is also a factor). Accordingly, in a Temperature Bin Analysis, the Engineer calculates the energy usage/hour of operation, for the equipment, at each temperature bin and multiplies that by the number of hours in that bin. They then sum the total energy for all the hours in the average year to obtain an average annual energy usage (and cost if so desired). This allows end users of these products to evaluate what their energy costs are for products they purchase and compare the performance of competing products.

This type of analysis has been in use for many years in many applications. It may be applied to any equipment that uses electricity in amounts that vary dependent on the weather for the location. However, to date these applications fail to include features that would increase the accuracy of the analysis, detracting from the value of the energy usage predictions.

There exists a need, therefore, for an improved methodology having new features integral to the calculation process that help make the results much more accurate.

### SUMMARY OF THE INVENTION

It is an object of this invention to provide an improved energy usage prediction software for compressors.

It is another object of this invention to provide an energy usage prediction software for refrigeration compressors using a Bin Analysis technique

It is yet another object of this invention to provide a bin analysis software for predicting energy usage in compressors having numerous novel features.

These objects, and others as will become apparent hereinafter, are accomplished by the present invention.

### BRIEF DESCRIPTION OF THE DRAWINGS

For a fuller understanding of the present invention, reference should now be made to the following detailed description thereof taken in conjunction with the accompanying drawings wherein:

FIG. 1 is indicative of the parameters considered by the Bin Analyzer of the present invention;

FIG. 2 is a first output showing performance parameters based on the parameters input in FIG. 1;

FIG. 3 is a second output showing performance parameters, including energy usage, based on the parameters input in FIG. 1;

FIG. 4 is indicative of the parameters considered by the System Analyzer of the present invention; and

FIG. 5 is a first output showing performance parameters based on the parameters, including energy usage, input in FIG. 4.

### DESCRIPTION OF THE PREFERRED EMBODIMENTS

The calculation of the projected annual energy usage for refrigeration compressors applied in a commercial and industrial refrigeration ‘racks’ can be achieved by use of a bin analysis method.

The analysis method of the present invention particularly includes (1) consideration of the effect of partial loading (through the use of capacity control devices) of compressors and the simulated application of a variable frequency drive on at least one of the compressors (2) consideration of the effect of externally compounded compression systems, (3) consideration of effect of the application of Evaporative type condensers applied to these commercial and industrial refrigeration ‘racks’ (4) consideration of the effect of the design saturated suction temperature moving within a specified range (or Dead-Band) as governed by a control device (5) the identification of all the possible/acceptable combinations of compressors (that meet the input criteria), and (6) performance of bin analysis type calculations for different combinations using the above-mentioned new features. The methodology then sorts the output of these different calculations based on least annual energy usage, least total compressor cost or a combination of these two parameters.

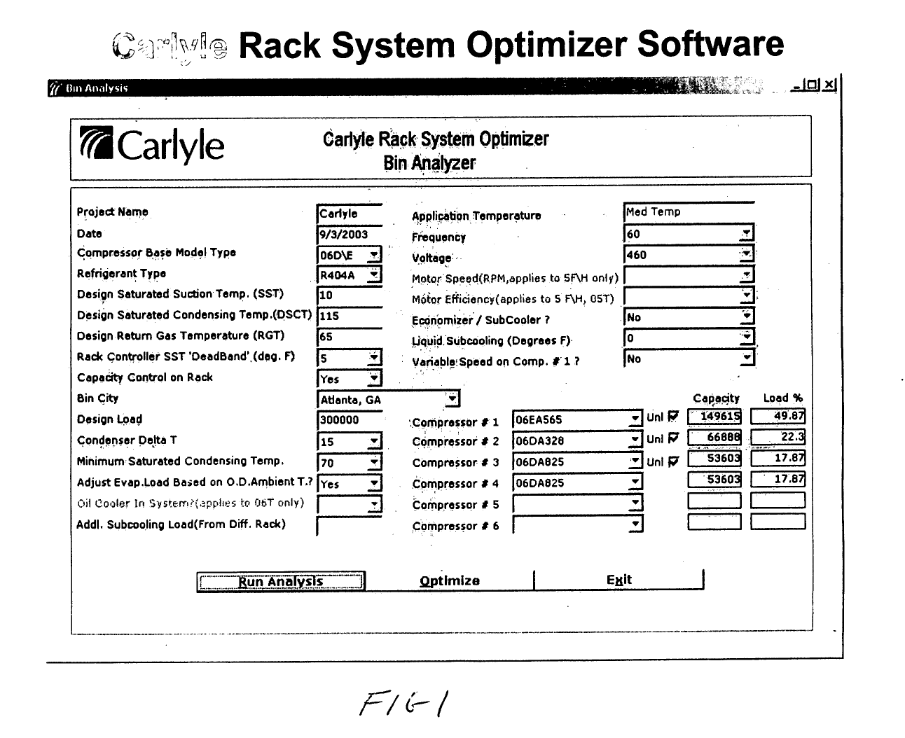

Specifically, the methodology of the present invention includes the steps indicated by FIGS. 1-5.

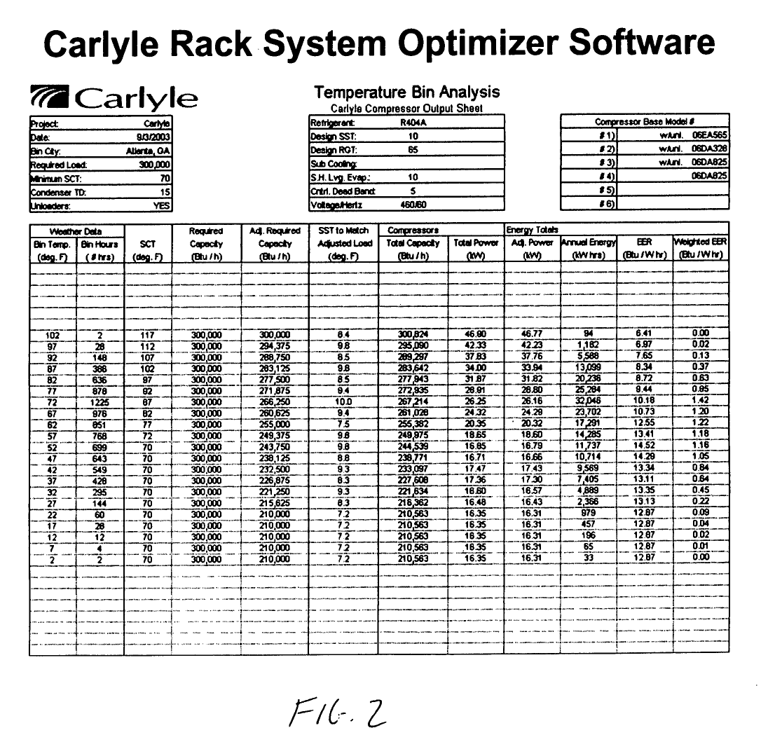

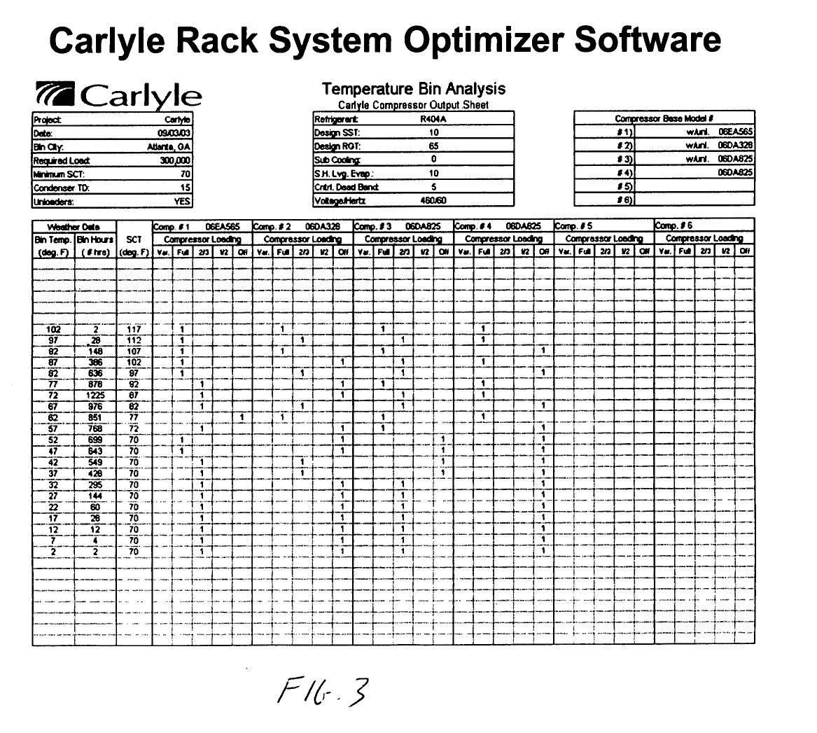

Referring to FIG. 1, the Bin Analyzer step, design considerations including saturated suction temperature, saturated condensing temperature and return gas temperature are considered as well as load, refrigerant, frequency, variable speed and other parameters. In addition, specific compressor models can be input in the optimization step and they may be input as unloaded as shown by the percentages. Taking into consideration the Weather Data, inclusive of Bin Temp and Bin Hours, as shown in FIG. 2, the optimization step calculates various parameters as shown, including adjusted required capacity, adjusted power, annual energy usage, and EER. FIG. 3. shows a further output of the methodology, again based on the weather data, including optimal compressor loading for different groups of Bin Temp and Bin Hours, for the compressor models input into the system.

After input of the various parameters, the methodology uses predefined ARI equations that consider the specific compressor coefficients, defining compressor performance, while making adjustments for other design conditions input into the system. At different temperature bins, the performance of the compressor changes due to the change in condensing temperature. Calculations for different bins are made by determining the average temperature within the bin and accordingly the compressor performance such as energy usage, and multiplying this result by the number of hours in that bin, yielding energy usage for that bin. The bins are added up over the course of a given period of time such as a year. Additional design criteria such as capacity is considered in the calculations, whereby the methodology yields at what percentage the compressors need to be running for the load to be met over the changing condensing temperatures, based on the bin data.

Accordingly the Bin Analyzer step yields performance data and energy consumptions, based on the weather data as well as ideal unloading characteristics; for the specific group of compressors input to the system.

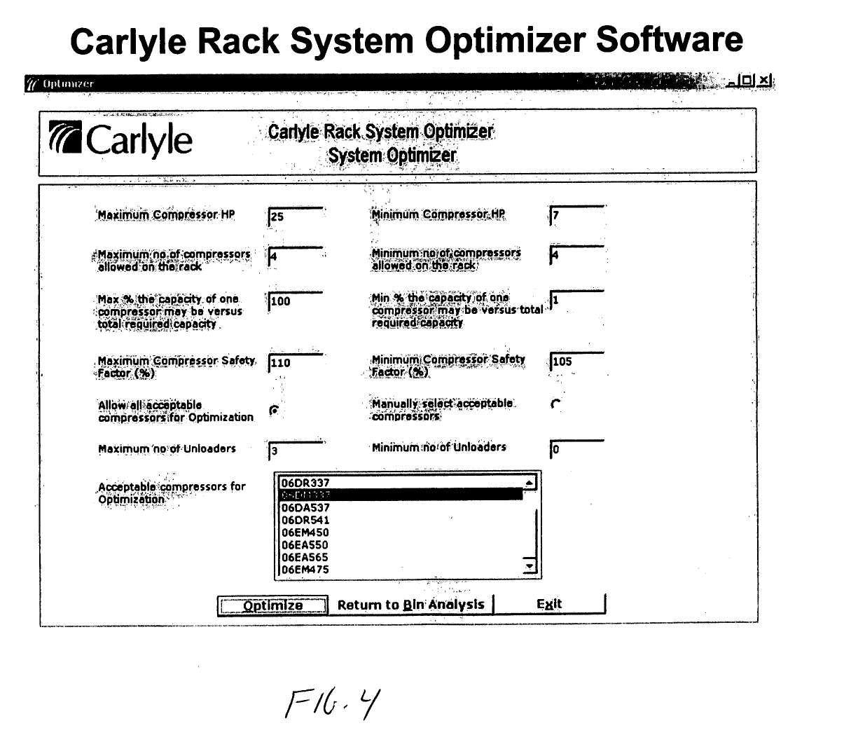

Referring to FIG. 4, a system optimizer step is shown and will be described. Along with the parameters previously input in the Bin Analyzer step, such as refrigerant, variable speed drive usage, city location, maximum load, etc, preferred system parameters are input, as shown in FIG. 4, including maximum compressor horse power, minimum compressor horsepower, maximum number of compressors, minimum number of compressors, maximum percentage capacity of one compressor versus the remaining compressors, minimum percentage capacity of one compressor versus the remaining compressors, maximum and minimum safety factors, and acceptable compressors, and several other parameters.

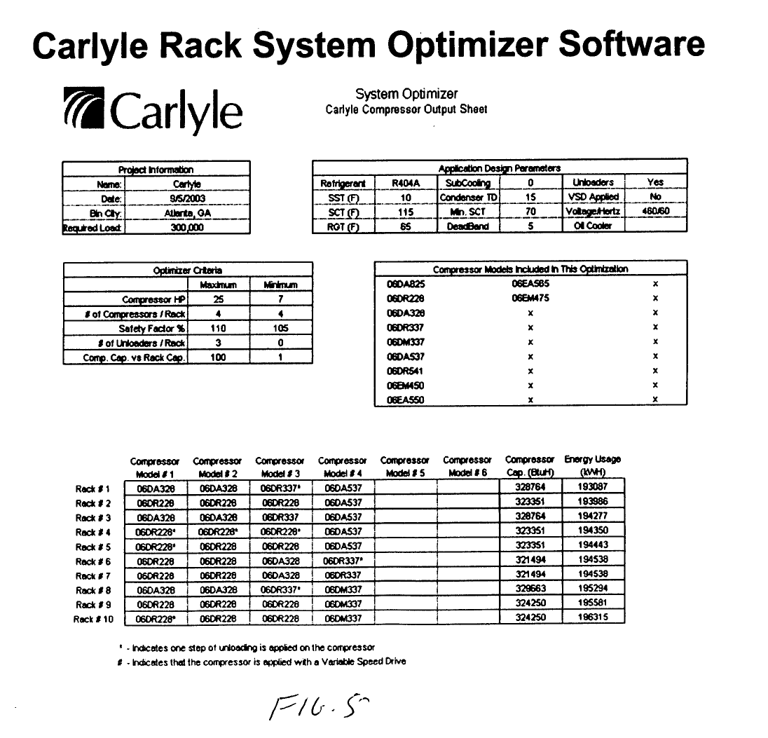

Optimization is then run and the methodology yields, in the manner described above using ARI equations, and considering bin data for the location identified, ideal compressor groupings, as shown in FIG. 5, meeting the input criteria and allowing for minimum energy usage.

While the invention has been described in reference to a preferred embodiment, it is to be understood by those skilled in the art that modifications and variations can be effected within the spirit and scope of the invention.

1. A method of calculating energy usage for compressor groupings including the steps of:
providing bin data for a specific geographical location;
inputting desired compressor models and quantities of compressors;
inputting compressor data including desired loading characteristics of the compressors;
calculating performance data including energy usage of the compressor groups; and
sorting groups based on least energy usage
